(19) United States
(12) Patent Application Publication
(10) Pub. No.: US 2012/0199662 A1
(43) Pub. Date: Aug. 9, 2012

(54) FLAIR SPRAYERS AND ISOLATION OF PRODUCT AND VENTING/PROPELLANT IN DISPENSING DEVICES

(75) Inventors: Wilhelmus Johannes Joseph MAAS, Someren (NL); Petrus Lambertus Wilhelmus Hurkmans, Someren (NL); Aaron S. Haleva, Oakhurst, NJ (US)

(73) Assignee: Dispensing Technologies B.V., DN Helmond (NL)

(21) Appl. No.: 13/289,874

(22) Filed: Nov. 4, 2011

Related U.S. Application Data
(60) Provisional application No. 61/456,349, filed on Nov. 4, 2010.
(60) Provisional application No. 61/518,677, filed on May 9, 2011.
(60) Provisional application No. 61/626,067, filed on Sep. 20, 2011.

(51) Int. Cl. A01G 25/09; B67D 7/58; A62C 11/00

(52) U.S. Cl. 239/1; 222/383.1; 239/333; 222/386.5

(57) ABSTRACT

A “Flair® Sprayer” can be provided with no dip tube, and can be capable of being used in any orientation, including upside down. Using a unique valving system, where the product delivery circuit is a closed system, a Flair Sprayer can pump out any gas in a bottle's headspace and the product/liquid always reaches the pump intake, even with no dip tube. A dispensing device can have separate product and re-venting/propellant circuits, isolated one from the other, allowing for longer life and freshness of the product. Air or other displacement media can be used for various ancillary functions, all the while remaining isolated from the product, and the dispensing of the product can be adeptly controlled by pressure differentials (under-pressures and overpressures).

### CROSS REFERENCE TO RELATED APPLICATIONS

This application claims the benefit of U.S. Provisional Patent Application Nos. (i) 61/456,349, filed on Nov. 4, 2010, (ii) 61/518,677, filed on May 9, 2011, and (iii) 61/626,067, filed on Sep. 20, 2011, the full disclosure of each of which is hereby incorporated herein by this reference as if fully set forth.

### TECHNICAL FIELD

The present invention relates to dispensing technologies, and in particular to novel sprayer devices using an inner container/outer container system that effectively separates the product being dispensed form air or other displacement medium used to vent and/or propel the product.

### BACKGROUND OF THE INVENTION

Liquid dispensing devices such as spray bottles are well known. Some offer pre-compression so as to insure a strong spray when the trigger is pulled and prevent leakage. Sprayers can be easily manufactured and filled, and are often used to dispense, for example, cleaners of all types, various liquid foodstuffs (e.g., olive oil, barbeque grilling aids, condiments, etc.), for example. It is often important to insure that the liquid in the sprayer does not come into contact with the outside air. Additionally, it is most useful not to have to use a dip tube in a sprayer bottle. When a conventional sprayer with a dip tube is used, the last portion of the liquid often cannot be sprayed out. Moreover, the sprayer often cannot spray due to a large headspace and due to the orientation of the sprayer bottle the liquid is not near the bottom of the dip tube.

What is needed in the art is a novel sprayer that solves these problems, and allows a user to spray it at any orientation, even upside down, not relying on a dip tube being required to suck up the liquid into the spray pump.

Additionally, conventional sprayers require venting, otherwise a vacuum can be created in the container bottle. Generally such venting is via an opening to the container bottle. This allows ambient air to mix with the product, and thus degrade it. Some systems use air or other displacement medium under a higher pressure to help push out the product. Some products significantly degrade when exposed to bacteria, or even oxygen in the air. This requires the inclusion of preservatives, which have their own effects upon a dispensed product and the environment. Some conventional sprayers and dispensing devices even allow air to remain in their piston chamber during a pumping stroke, and thus mix with the outflow, and this is always in an uncontrolled manner.

What is further needed in the art is a sprayer technology that allows for a complete separation between the product and ambient air or other propellant medium.

### SUMMARY OF THE INVENTION

Various liquid dispensing devices are presented based on Flair® technology. In exemplary embodiments of the present invention, a “Flair Sprayer” can be provided with no dip tube, and can be capable of being used in any orientation, including upside down. Because of its unique valving system, in which the product delivery circuit is a closed system, such a Flair Sprayer can pump out any air or other gas in a headspace of a bottle, and the product/liquid always reaches the pump intake, even with no dip tube. In exemplary embodiments of the present invention a dispensing device can have separate product and re-venting/propellant circuits, isolated one from the other, allowing for longer life and freshness of the product. In such exemplary embodiments air or other displacement media can be used for various ancillary functions, all the while remaining isolated from the product, and the dispensing of the product can be adeptly controlled by pressure differentials (under-pressures and overpressures).

### BRIEF DESCRIPTION OF DRAWINGS

It is noted that the patent or application file may contain at least one drawing executed in color. If that is the case, copies of this patent or patent application publication with color drawing(s) will be provided by the U.S. Patent and Trademark Office upon request and payment of the necessary fee.

FIG. 1 depicts an exemplary Flair® trigger sprayer without a dip tube according to an exemplary embodiment of the present invention;

FIG. 2 illustrates how pre-compression allows such an exemplary sprayer to pump air;

FIG. 3 depicts pumping air out of a headspace according to an exemplary embodiment of the present invention;

FIG. 4 depicts repeating pump sequence to remove headspace according to an exemplary embodiment of the present invention;

FIG. 5 depicts how pre-compression enables controlled gas release according to an exemplary embodiment of the present invention;

FIG. 6 depicts exemplary sprayers according to an exemplary embodiment of the present invention;

FIG. 7 depicts an enlarged view of one of the exemplary sprayers of FIG. 6;

FIG. 8 depicts a conventional sprayer or dispenser, where neither the liquid stream is controlled, and the venting air is mixed with the product being dispensed;

FIG. 9 depicts a distribution of the various pressures at which droplets are expelled over time in a conventional sprayer or pump type dispenser;

FIG. 10 depicts a “One Pak” type sprayer, where the liquid stream is controlled as to pressure but the dispensed product is still allowed to mix with a re-venting medium;

FIG. 11 depicts a comparison of the distribution of the various pressures at which droplets are expelled over time in (i) a conventional sprayer or pump type dispenser versus (ii) a controlled One Pak type sprayer;

FIG. 12 depicts an exemplary system where contents/product and propellant are provided in two separate and distinct circuits, according to an exemplary embodiment of the present invention;

FIG. 13 depict an alternate exemplary system where contents/product and propellant are provided in two separate and distinct circuits, according to an exemplary embodiment of the present invention;

FIG. 14 depict yet another exemplary system where contents/product and propellant are provided in two separate and distinct circuits, according to an exemplary embodiment of the present invention;

FIG. 15 depicts how, given two separate and distinct product and propellant circuits, a propellant can be used for a variety of supportive and ancillary functions in a given dispensing device according to exemplary embodiments of the present invention; and

FIG. 16 depicts the integration of liquid control and separation of product and dispensing medium into two separate circuits according to exemplary embodiments of the present invention.

### DETAILED DESCRIPTION OF THE INVENTION

In exemplary embodiments of the present invention various liquid spraying devices offer the benefits of both a liquid sprayer and an aerosol can, or, for example, improved dispensing pumps of all sizes, such as, for example, finger pumps, lotion pumps, etc. Such exemplary devices are sometimes referred to herein as “Flair Sprayers” and Flair” devices, given that they incorporate the “bag within a bag” or inner container/outer container Flair® technology developed and provided by Dispensing Technologies, B.V. of Helmond, The Netherlands.

It is noted that Flair® technology generally involves various bag in bag, or bag in bottle devices integrally molded from one or more performs in which a displacing medium can be introduced between the outer container and an inner container so as to empty the contents of the inner container without said contents ever coming in contact with the displacing medium. Flair® Technology also includes valves, nozzles, pumps and other parts and ancillary equipment used in connection with such bag in bag, bag in bottle, or inner container/outer container technologies. The present invention is directed to various uses of Flair® Technology as applied to sprayers, dispensing devices and systems where there are two separate and distinct circuits; one for the product or liquid to be dispensed, and another for a propellant or venting medium.

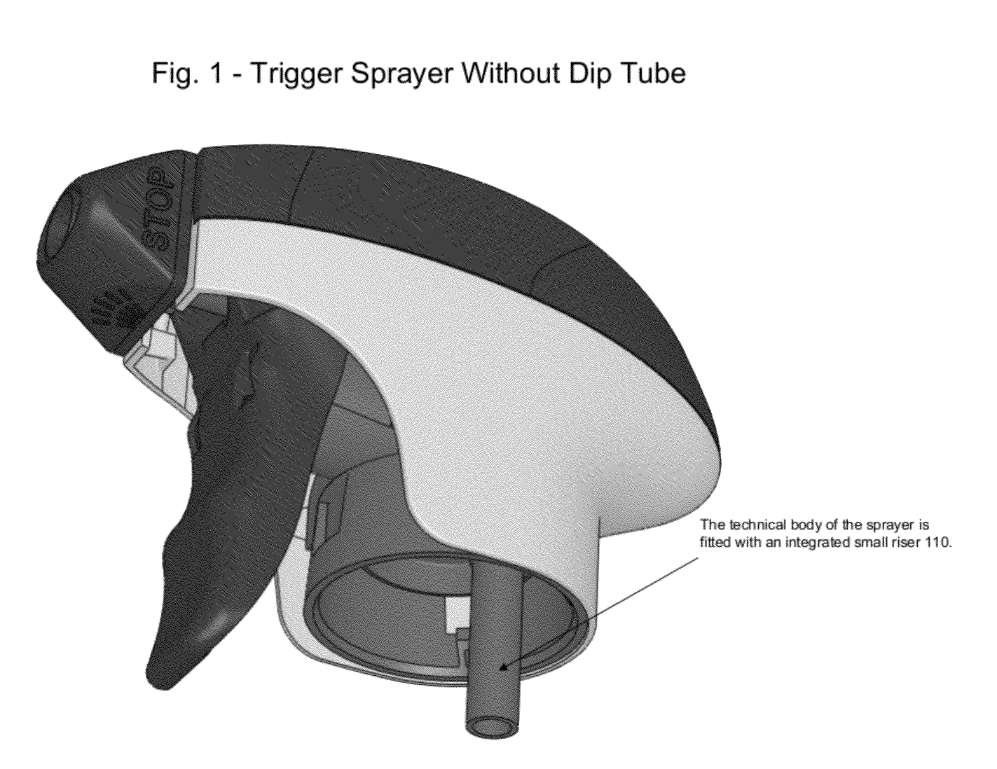

FIG. 1 depicts an exemplary Flair® trigger sprayer without a dip tube. As can be seen at the bottom of FIG. 1, the body of the sprayer is fitted with an integrated small riser 110 in place of a dip tube. In alternate exemplary embodiments of the present invention, even this riser can be eliminated, inasmuch as the liquid can be brought to the necessary level by pumping whenever the sprayer is operated, as described below.

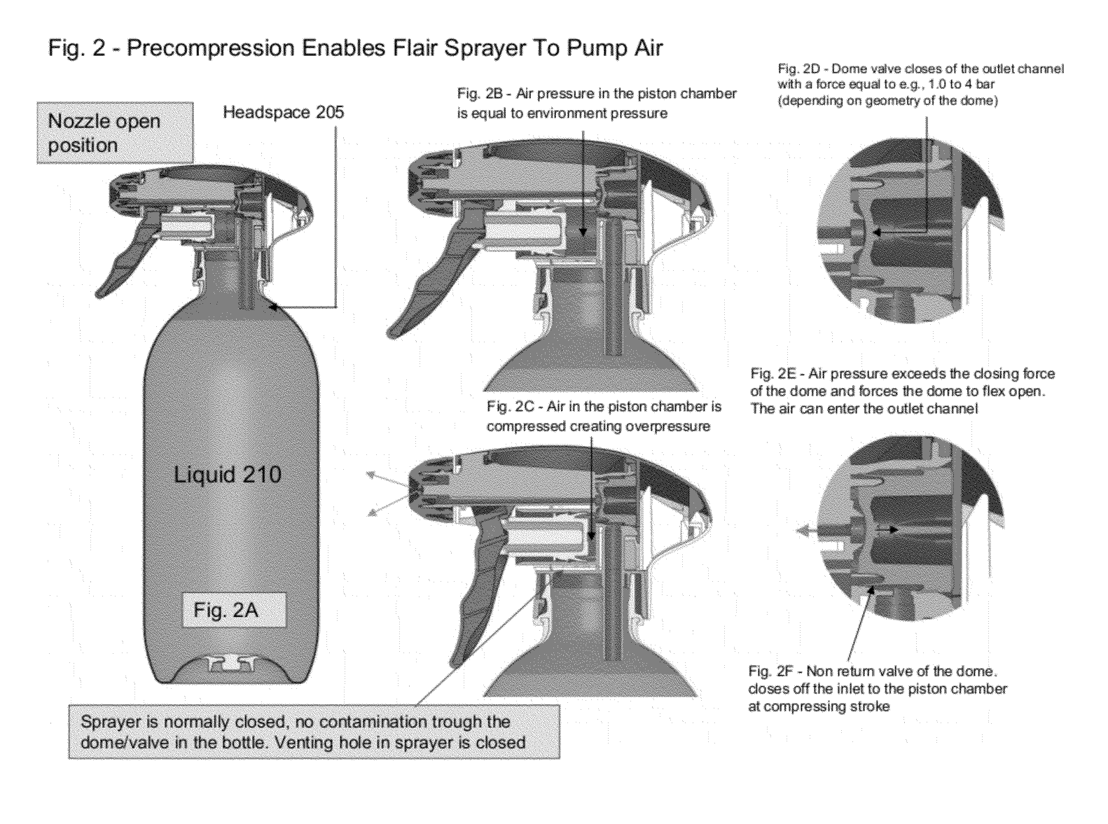

FIG. 2 illustrate how pre-compression allows such an exemplary sprayer to pump air. Pre-compression is a technique also developed and improved upon by AFA Polytek, B.V., a company related to the assignee hereof, and involves requiring the liquid in a sprayer or sprayer type device (such as, for example, a Flair Sprayer or a Trigger Flair device as described below) to reach a certain pressure before it can be ejected. This guarantees that there is always a strong stream and that the stream has a small distribution of particle velocities due to the fact that overall pressure is precisely controlled. Pre-compression is achieved by a set of valves by which liquid 210 is drawn into a piston chamber, but cannot leave the piston chamber to an outlet channel unless it exceeds a predetermined pressure. As shown in FIG. 2D, this predetermined pressure is the force by which a valve, here, for example, a dome valve (but various other types of valves can be used as well), closes the outlet channel, and can be, for example, between approximately 1.0 to 4.0 bar, or, for example, the pressure necessary to open such valve can have various other values, as appropriate. The liquid ultimately sprayed from such pre-compression devices can have a range of pressures, according to a normal (Gaussian) distribution, and can be, and often is, higher than such minimum pressure, up to a certain maximum for that sprayer, but they all must exceed this minimum outlet valve opening pressure or there is no spray. This is described more fully below.

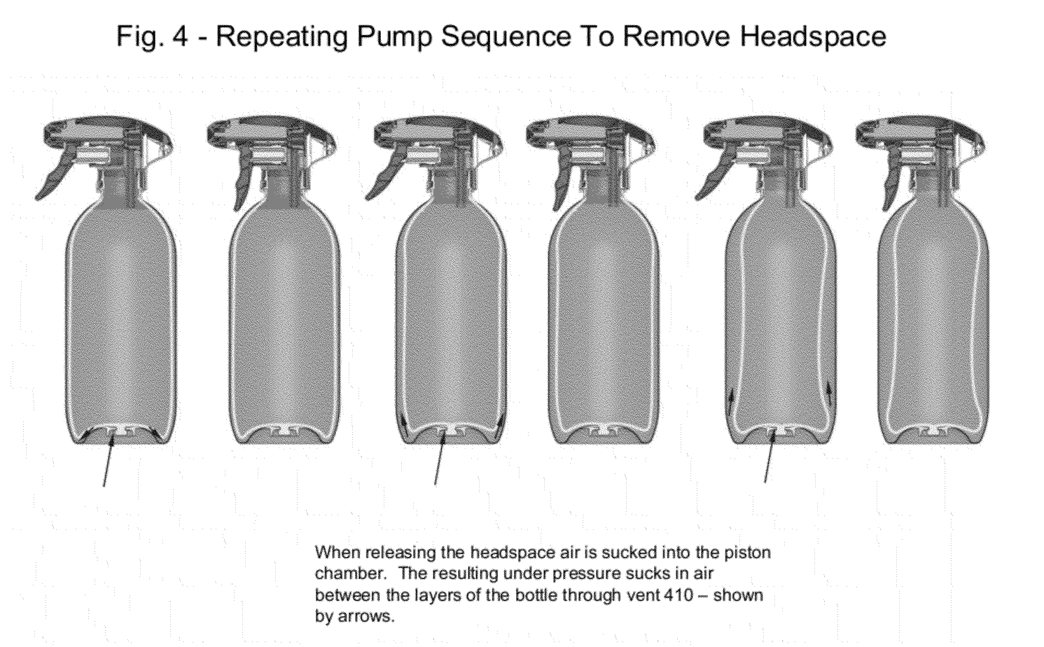

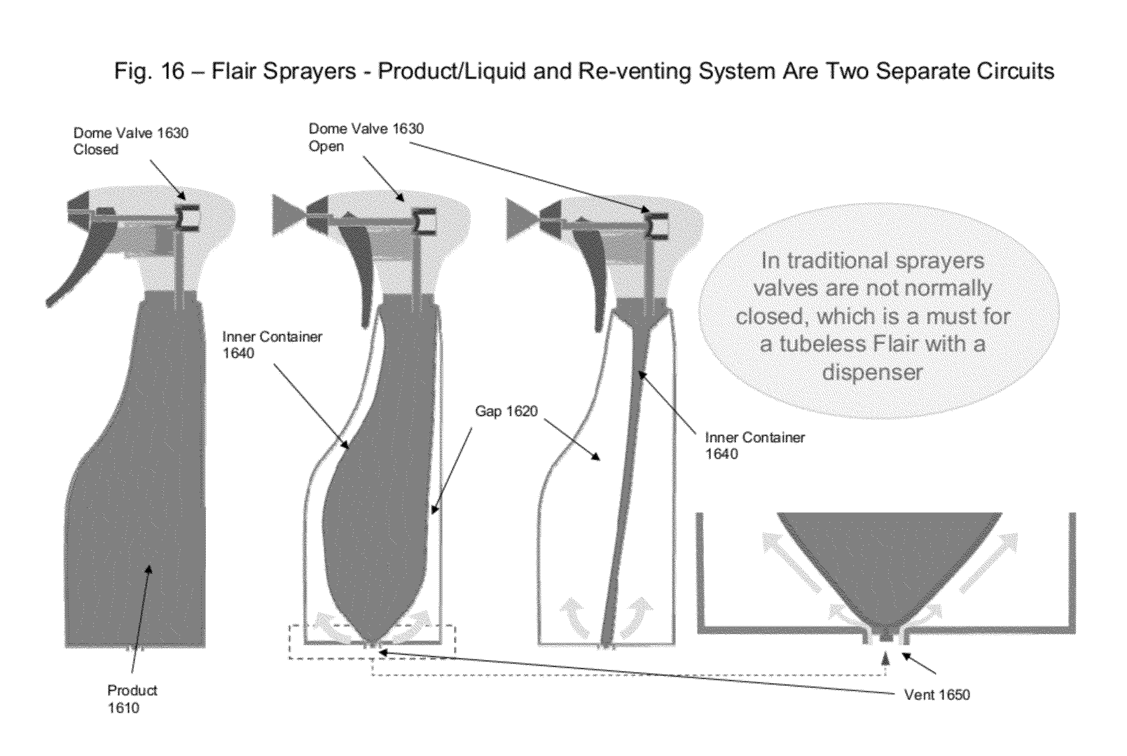

As can be seen with reference to FIG. 2 an exemplary sprayer has an outer container wall as well as an inner bag or inner container (when full of liquid, the inner container's outer walls are pushed up against the inner walls of the outer container, as here in FIG. 2, better views of the inner/outer containers are seen in FIGS. 4 and 16 for this example). As shown below, a displacing medium such as air, for example, can be provided between these two layers. With reference to FIG. 2A, there is a liquid 210 in the inner container, as well as a headspace 205 on top of the liquid. Headspace 205 can contain air, or, for example, air mixed with a gas released by the liquid. As shown in FIG. 2B, air pressure in the piston chamber is initially equal to environmental pressure.

With reference to FIG. 2C it is also noted that the sprayer is normally closed to the outside, thus there can be no contamination from the outside air via some backflow into the outlet channel through the dome valve in the bottle. Moreover, there is no venting hole in the sprayer as is commonly found beneath the piston chamber or thereabouts, as shown in FIG. 2C and pointed to by the orange arrow. The air pressure in the piston chamber is originally equal to environmental pressure, as shown in FIG. 2B, but once a user squeezes on the trigger, the air in the piston chamber is compressed, which thereby creates an overpressure in the piston chamber. This overpressure is applied on the left side of the dome (outlet) valve (shown in pink at the top right of the sprayer in these figures), from the liquid in the piston chamber. Details of this dome valve are provided in FIGS. 2D and 2F. The pressure in the piston chamber can also increase due to off-gassing from a gas containing liquid in the inner container of the bottle (without any compression due to user pumping), as described more fully below.

As shown in FIG. 2D, the dome valve can have, for example, a cracking pressure which depends on its geometry and can be, for example, between approximately 1.0 to 4.0 bar. Continuing with reference to FIG. 2E, once the air in the piston chamber is compressed (or increased due to off-gassing form the liquid), if the overpressure is high enough it exceeds the cracking pressure of the dome valve, which then forces the dome to flex open and allows the air (or gas) to enter the sprayer's outlet channel. It is also noted, as seen in FIG. 2F, that the exemplary dome valve performs “double duty.” Thus, is also a one way (“non-return”) inlet valve inasmuch as there is a non return valve functionality associated with it, as shown, gating the inlet to the piston chamber. This closes off the inlet to the piston chamber during a compression stroke. In a compression stroke the piston also fully fills and closes the piston chamber in a flush fit, there being no volume left in the piston chamber at all, given the shape and geometry of the piston and the outer ring at its right side, as shown below. This is sometimes known as “making the volume dead.” It is noted, as shown in FIG. 2, that the [sprayer head+inner container] system is normally closed, and thus has no open air path to the outside. It is this normal condition that allows its functionality of no dip tube being required, and its ability to pump out air from the headspace.

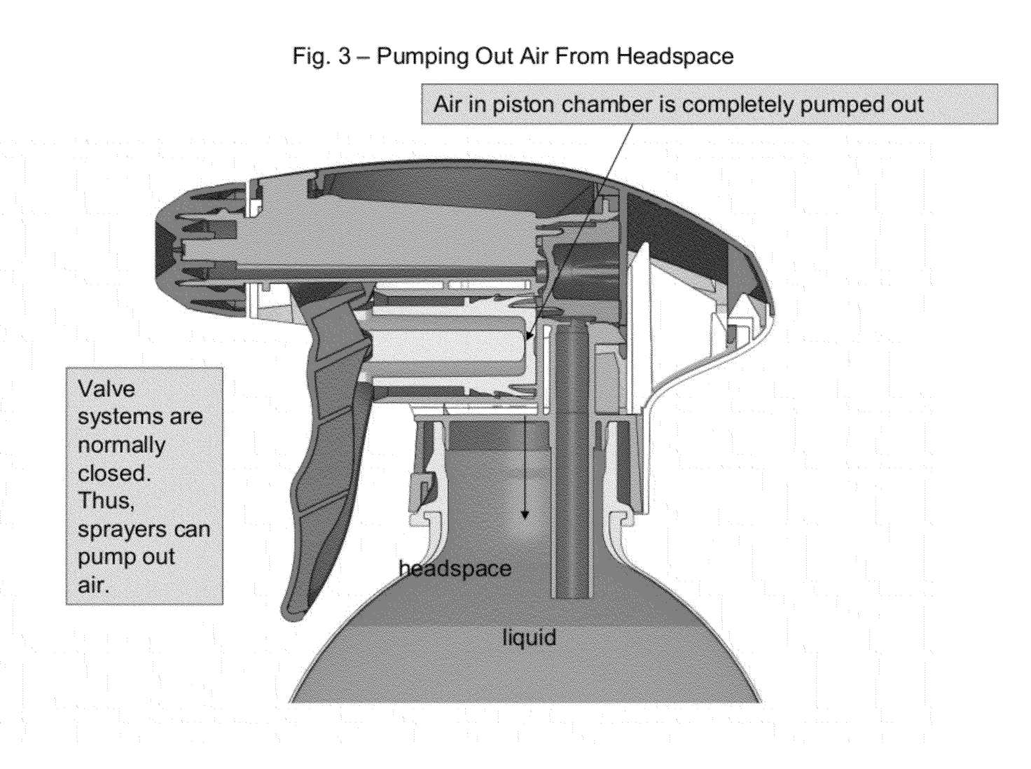

FIG. 3 is an enlarged view of the exemplary trigger sprayer of essentially FIG. 2C, but after all of the air has been completely pumped out of the piston chamber (competing the process shown in FIGS. 2B and 2C). It is noted that because sprayer heads which can be used according to exemplary embodiments of the present invention, such as, for example, the OpUs or OpAd sprayers provided by AFA Polytek, B.V., are normally closed systems, with no open air inlets, they can pump air out of the bottle or container to which they are attached. As noted in connection with FIG. 2C, there is no open air intake path to/from the outside into either the piston chamber or the outlet channel when the valves are in their normal (i.e., closed) positions. The liquid or product path is thus isolated from the ambient atmosphere.

FIG. 4 illustrates six exemplary steps in what happens as the air in the headspace is pumped out of the top of the sprayer container and into the piston chamber of the sprayer, as described above. Beginning at the left of FIG. 4 and ending on the far right of FIG. 4, air is pumped out of the headspace such that the liquid rises to cover and then rise slightly above the riser. As can be seen, as the air is being pumped out of the headspace the inner container actually shrinks widthwise, which is what allows for the level of the liquid to rise. The reason the inner container shrinks is because as the headspace air is pumped out of the inner container an under pressure occurs in the inner container. In order to equalize the pressure air is sucked in from a one way vent 410 at the bottom of the sprayer bottle between the two layers of the bottle, which causes air to fill the gap between the inner and outer containers and the inner container to thereby shrink. FIG. 4 shows this air movement by the blue arrows in the first, third and fifth of the illustrated steps (starting form the leftmost image). Notwithstanding such venting, the contents of the inner container never contact the atmosphere, because, as noted, the sprayer being normally a closed system, except when gas or liquid is sprayed out the outlet channel.

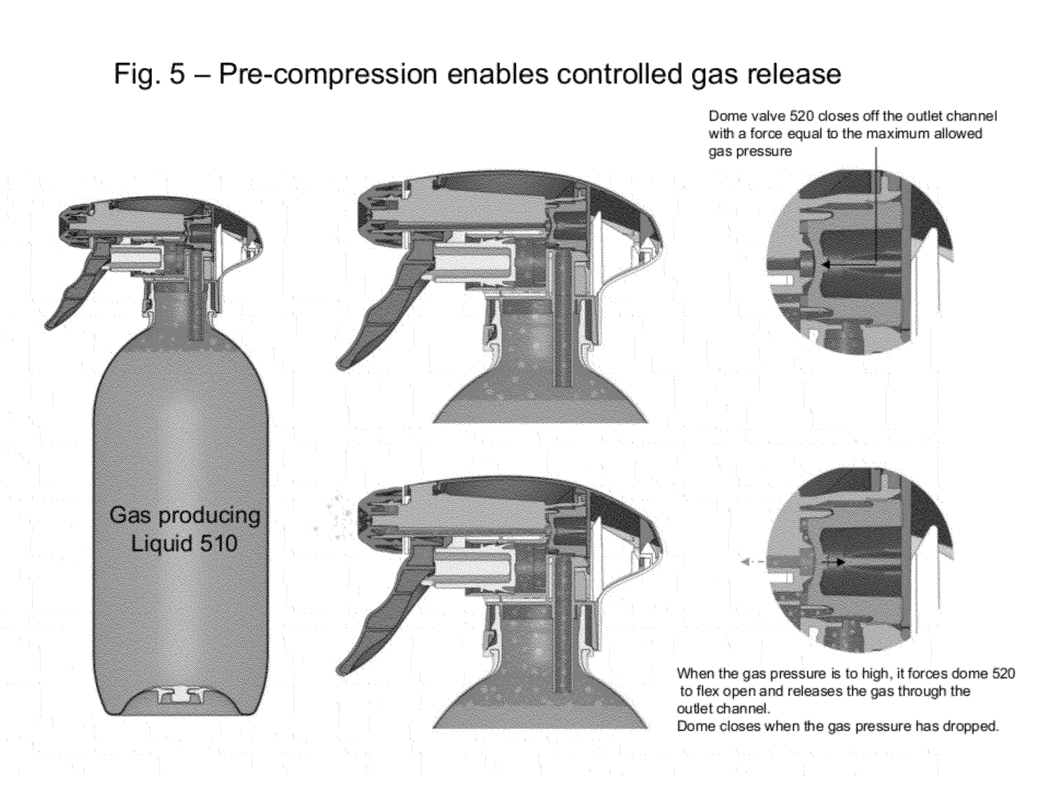

FIG. 5 illustrates how the pre-compression functionality of the exemplary sprayer of FIG. 1 can allow a gas dissolved in a liquid to escape. It is noted that in medical applications, for example, there is often a gas dissolved in a liquid, or created when two liquids are mixed, or in similar situations. With reference to FIG. 5, there is seen a gas producing liquid 510 on the far left of FIG. 5, and, as shown in the center figures of FIG. 5, as the gas pressure reaches a certain value sufficient to open the dome valve 520 the dome flexes open and releases the gas to the outlet channel (lower center figure), and then the dome closes once again when the gas pressure applied to it has dropped (upper center figure). Detail of the dome valve 520 functionality is shown in the right column of figures of FIG. 5. As noted, the dome valve is a one way valve and of course gas can escape through the outlet channel of the sprayer but no air or other gases in the surrounding area of the sprayer can enter the sprayer. In exemplary embodiments of the present invention, the dome can be made of a plastic material, or other material, such as, for example, metals, composites, etc., sufficiently strong to withstand the pressures and sufficiently flexible to be deformed at some useful minimum deforming pressure. In exemplary embodiments of the present invention, such a dome can be replaced with any equivalent valve, or by a set of inlet and outlet valves. The key functionality being to have a minimum pressure required to open an outlet path, and on the inlet side, to be a one-way (no return) valve, as described above.

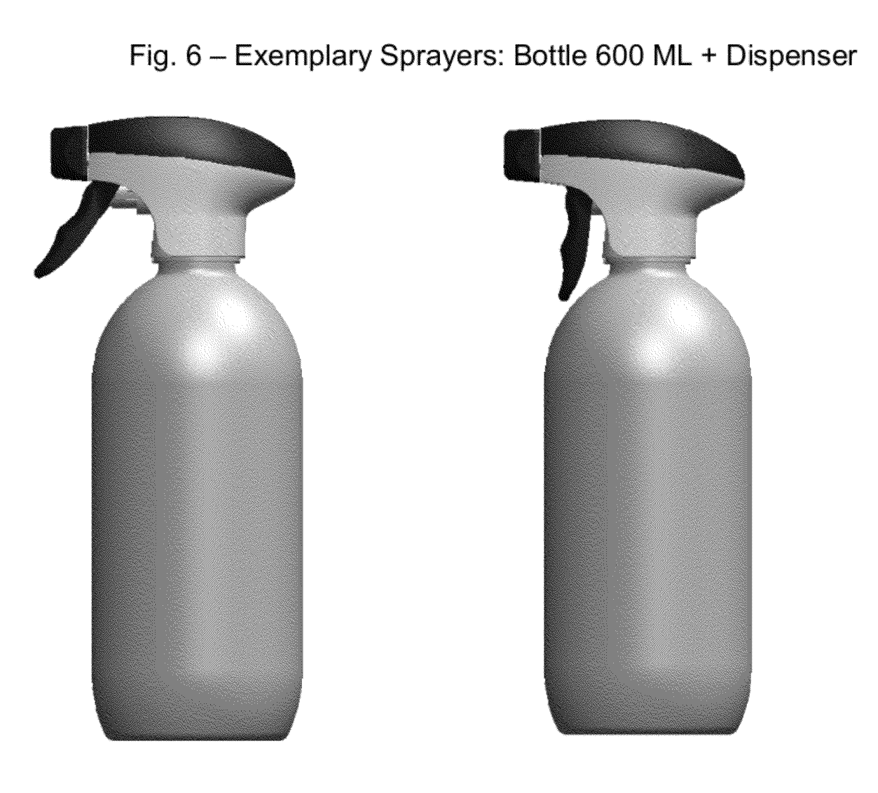

FIG. 6 illustrates an exemplary Flair Sprayer with an exemplary 600 ml bottle, where the sprayer trigger is in the home or normal position (left panel) and in the compressed position (right panel) according to exemplary embodiments of the present invention.

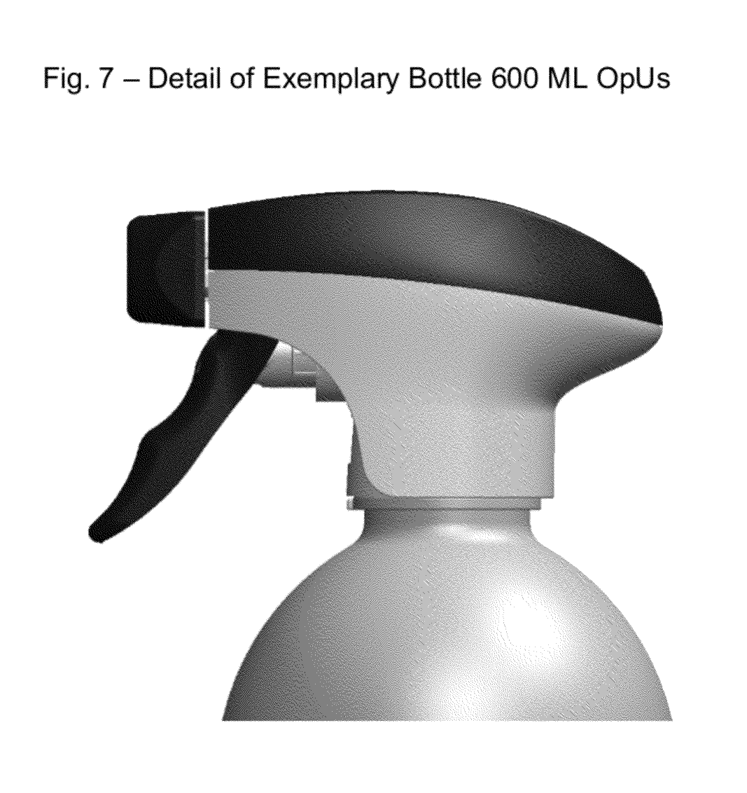

FIG. 7 is a detailed view of the Flair Sprayer head of FIG. 6 with the trigger in the normal or home position according to exemplary embodiments of the present invention. These figures indicate that such a sprayer can be implemented as a Flair enabled version of an OpUs sprayer as provided by AFA Polytek, B.V. of Helmond, the Netherlands, a related company to assignee hereof. The sprayer head can also be used with various other Flair based versions of AFA Polytek sprayers, such as, for example, its OpAd, One-Pak, and other similar sprayers where the sprayer and bottle are normally a closed system, and sealed off from the atmosphere (no venting to atmosphere), as noted above.

In the sprayers of FIGS. 6-7, as well as in all Flair® based sprayers according to exemplary embodiments of the present invention, no venting in the sprayer is necessary and no dip tube is necessary, due to the Flair® bottle with bag inside, and the isolation of product delivery circuit from the venting circuit functionality that it provides. It is noted that a Flair® Sprayer—or any sprayer, actually, should have head space while it is on-shelf if it contains a liquid that has a dissolved gas, or contains a liquid that can readily off-gas. This is seen in connection with FIGS. 3-4. If the liquid is already at the level of the small riser, or if no riser, at the level of the intake at the bottom of the valve body, and then the pressure in the (closed) inner container rises due to the dissolved or newly created gas, this can push liquid up into the piston chamber, and if sufficiently pressurized to open the dome or other outlet valve, out the outlet channel, causing a mess and potentially harmful chemicals to be released on a store's shelf, for example.

It is also noted that in exemplary embodiments of the present invention, because the Flair Sprayer uses Flair® technology, the inner bottle will always be compressed by ambient pressure in the gap between the inner container and outer container so as to shrink as the liquid is sprayed out over time. Thus, as is the case with all Flair® technology, whatever liquid remains in the inner bottle is always available to be drawn by the piston into the piston chamber and then sent into the pressure chamber. No air pockets or gaps develop in the inner Flair® bottle. Hence the efficacy of combining Flair® technology with a clean or “green” pseudo-aerosol pressurized liquid spraying functionality, as in the various embodiments of the present invention.

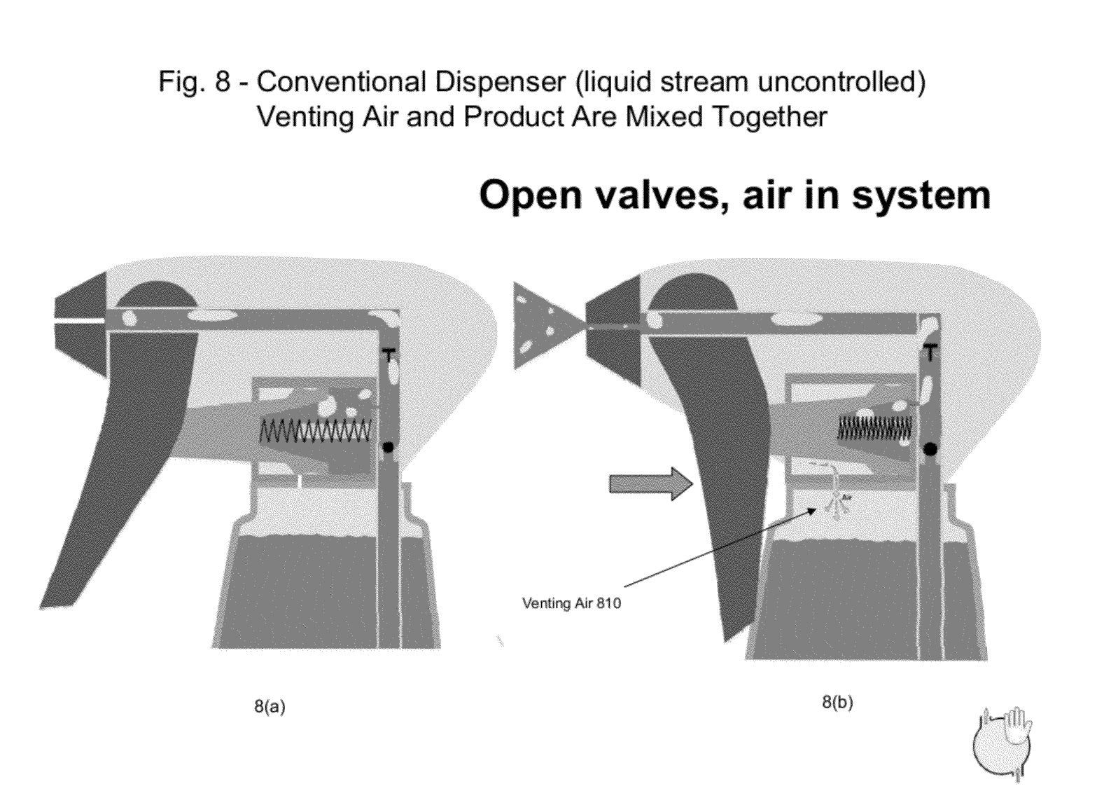

FIG. 8 illustrates the functionality of a conventional sprayer dispenser. Originally sprayers did not control the liquid stream as to uniformity or velocity. Uniformity or velocity is always a function of the pressure at which various droplets in the flow stream are dispensed from the sprayer. With reference to FIG. 8, the left panel shows an uptake stroke and the right panel shows a down stroke or spraying stroke. As can be seen with reference to FIG. 8, the piston chamber is provided with a spring which itself is located within the piston chamber. As a result, air bubbles (shown in white in the otherwise blue liquid flow) that are introduced—by compression of the spring or otherwise—are pushed through in the pumping stroke shown in FIG. 8(b). Similarly, these are ejected as part of the spray, further introducing randomness and erratic behavior in the spray flow and in the outflow channel. As can also be seen in FIG. 8, at the end of a down stroke, as seen FIG. 8(b), venting air 810 is allowed to enter the product chamber through a small hole at the bottom of the piston chamber (through which arrows of air are shown entering the product chamber in FIG. 8(b)). Thus, venting air 810 is nothing more than ambient air and the product container is completely mixed with and exposed to the ambient air. This was a very standard approach in conventional sprayers and similar dispensing devices and therefore they did not have a sealed off valve or piston chamber. Because of their open valves, air always entered these systems.

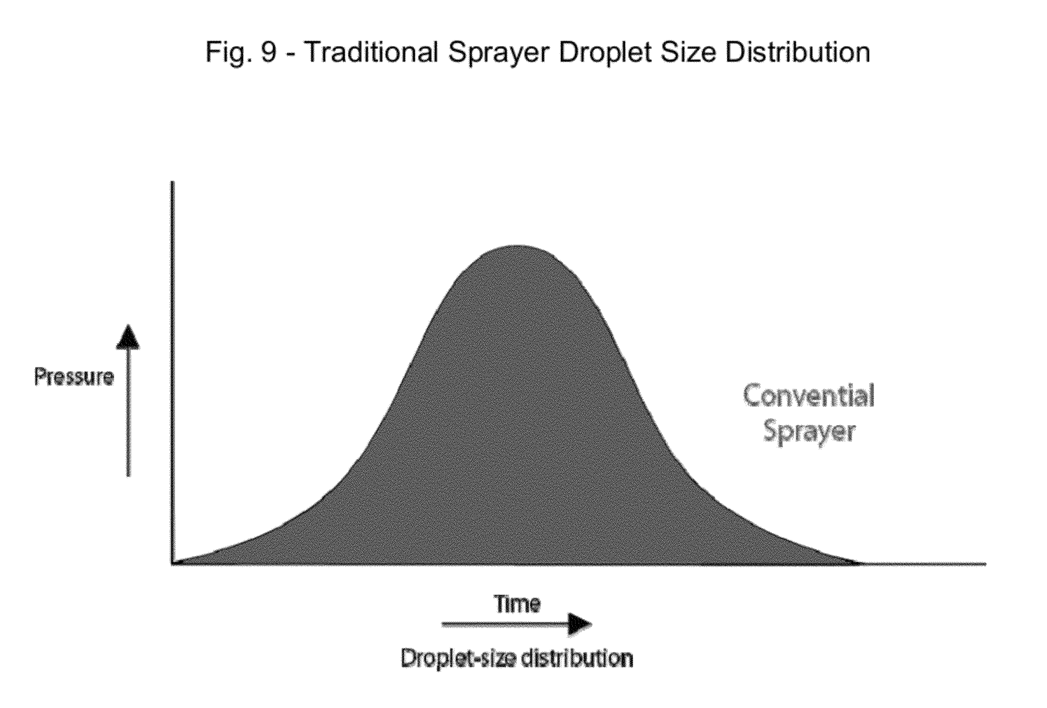

FIG. 9 is a plot of droplet size distribution over time and the pressures that such droplet sizes have as they are sprayed from a conventional sprayer. As can be seen in FIG. 9, at an initial time, just as a user begins pumping, droplets are expelled with very low pressure. Then as more pumping is performed and the pressure builds in the system, the pressure on droplets increases, to the maximum seen at the top of the Gaussian distribution. Finally, as a user stops or winds down and then stops spraying, the pressure once again drops. There is no minimum pressure required for a droplet to be expelled in this type of conventional sprayer and therefore, as can be seen with reference to FIG. 9, there is a wide variety of droplets and droplet sizes, and thus no consistency. A user spraying onto a surface will see drops falling in a large area, with some randomness.

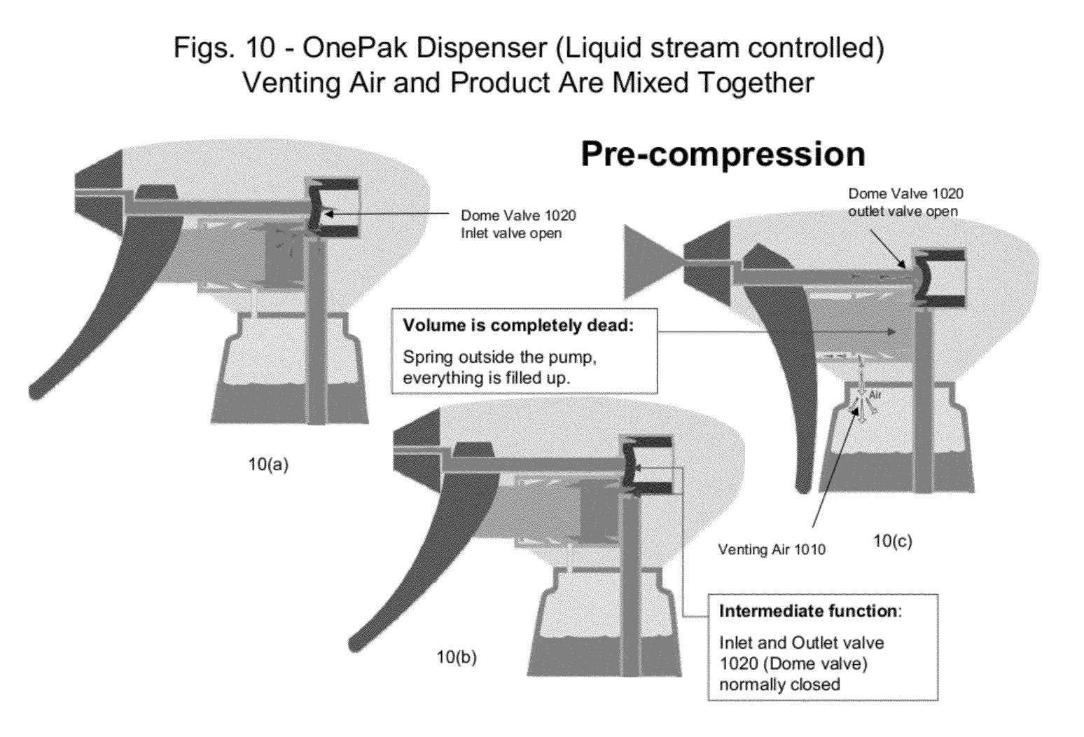

FIG. 10 depicts an advance over the conventional sprayer of FIG. 8. FIG. 10 depicts the functionality of a “OnePak” dispenser. The OnePak dispensers are provided by AFA Polytek B.V. of Helmond, The Netherlands. The OnePak dispenser added precompression. Precompression is the use, in a dispensing system, such as a sprayer, of an internal valve that does not open unless a minimum pressure is reached. Additionally, the OnePak type dispenser also provided the spring—which returns the trigger or actuator connected to the piston to its original position—outside of the piston chamber or pump. Therefore, there is no room for stray air bubbles associated with or aggregated on a spring within the piston chamber to become mixed into the fluid flow, and no physical interaction between the spring and the liquid being dispensed. However, as seen in FIG. 10(c), at the end of the pumping stroke, venting air 1010 enters the product chamber via a hole in the piston chamber in a completely analogous manner to that shown in FIG. 8(b) above.

The precompression provided by the OnePak type sprayer is illustrated by comparison of FIGS. 10(a), 10(b) and 10(c). With reference to FIG. 10(a) what is depicted is a filling stroke where the spring (not shown) pushes the trigger to its fully opened position (leftwards in FIG. 10(a)) and liquid is sucked up from the product container through the dip tube into the pump or piston chamber. This is shown in FIG. 10(a) by the small arrows in the dip tube pointing upwards and towards the left into the pumping chamber. It is noted that dome outlet valve 1020 remains closed and there is no flow into the outlet channel.

In FIG. 10(b), the beginning of a pumping stroke is shown, where the piston pushes liquid towards dome valve 1020 which is still closed. The particular dome valve shown in FIG. 10 is functioning both as an inlet valve and an outlet valve such that during a pumping stroke, as is shown in FIG. 10(b), there is no longer any inlet from the dip tube or central vertical channel into the piston chamber as was the case in FIG. 10(a). Thus, in FIG. 10(a), dome valve 1020 is closed in its capacity as an outlet valve but as shown by the small arrow at the bottom left of dome valve 1020 in FIG. 10(a), in its capacity as an inlet valve, it allows liquid to flow from the central vertical channel into the piston chamber as shown by the small arrows.

Finally, as shown in FIG. 10(c), dome valve 1020 is open in its capacity as an outlet valve (although closed as an inlet valve—similar to the case of FIG. 10(b)), and thus fluid flows from the piston chamber past dome valve 1020 and into the outlet channel. As a result, there is a spray as seen in FIG. 10(c) exiting the nozzle (shown by the blue triangle). As is also shown in FIG. 10(c), the volume of the piston chamber is completely zero, and all contents have been evacuated. Also noted in this configuration, the piston no longer blocks the air vent between the piston chamber and the product chamber and venting air 1010 flows inwards to the product chamber.

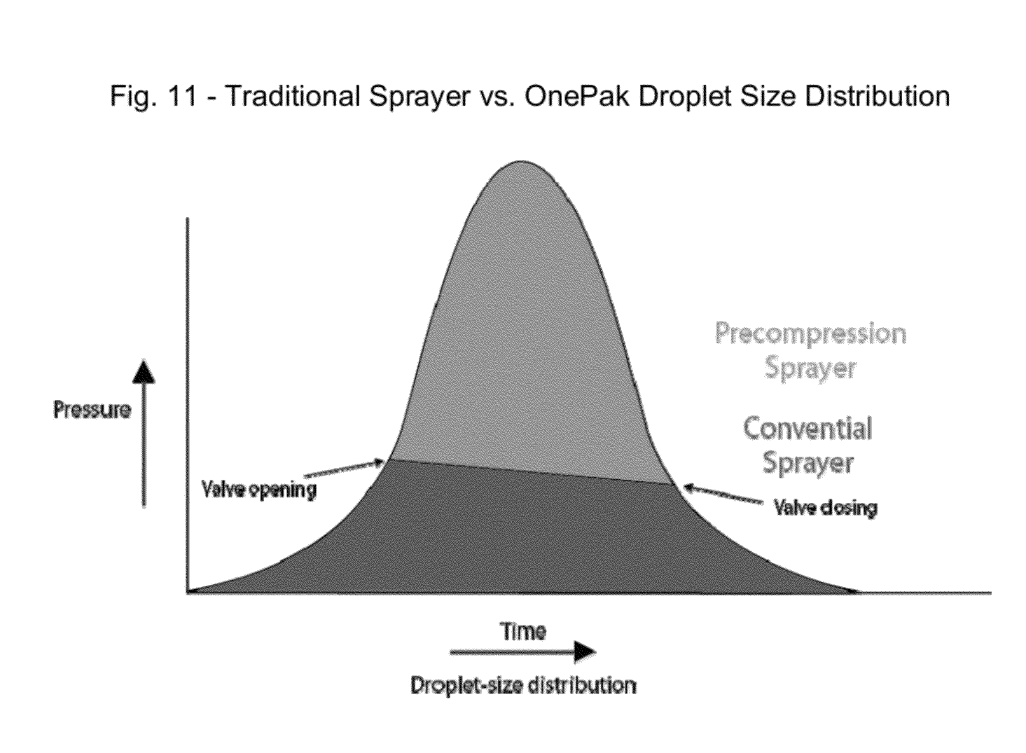

The OnePak type dispenser changes the pressure profile of droplets leaving the sprayer. This is shown in FIG. 11. With reference thereto, the portion at the top of the parabola (colored in green), shows the droplets that are allowed to leave the OnePak type sprayer. The red portion of the parabola indicates those droplets that a conventional sprayer allows to exit from the sprayer, but that the OnePak type or precompression type sprayer does not. Therefore, as can be seen, it takes a certain minimum pressure to open dome valve 1020 (FIG. 10) and this occurs some time after a user starts pumping on the sprayer and drops off some time before the user stops pumping. When the pressure drops, this minimum pressure is no longer supplied to dome valve 1020, thus dome valve 1020 closes, and no further droplets are emitted from the sprayer. Therefore, using pre-compression, the set of all droplets leaving the sprayer is much more controlled, happens at a more narrow time interval and has minimum pressure above which all droplets are expelled which controls the velocity and droplet size to be more uniform for any spray.

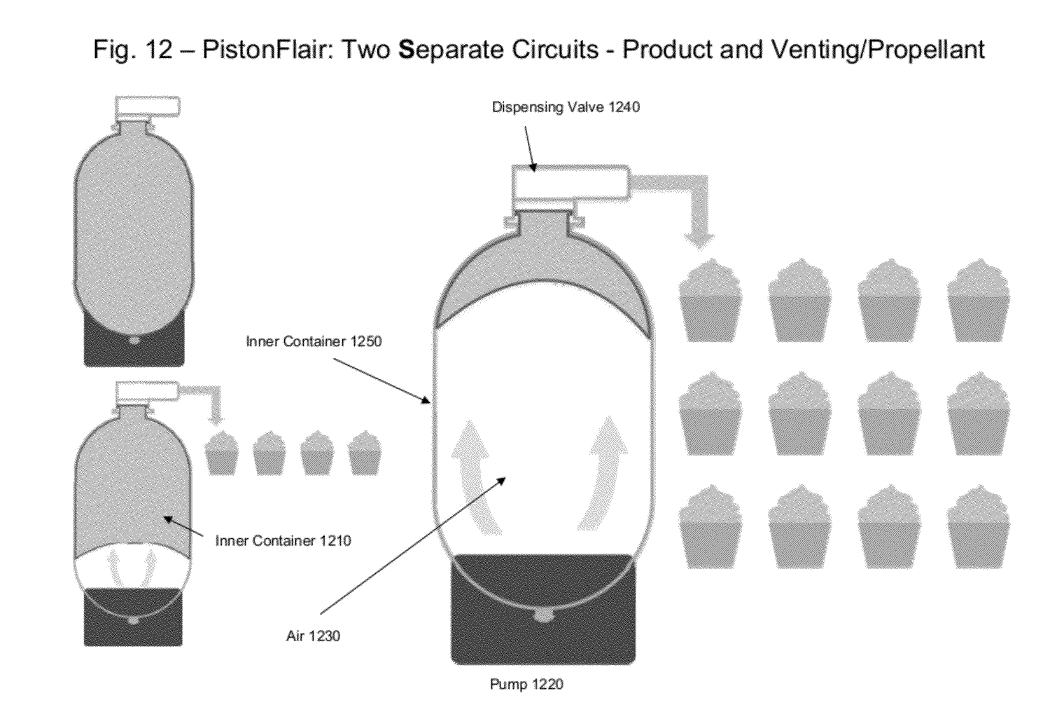

There is another feature however, that the OnePak sprayer did not have which, in exemplary embodiments of the present invention, any dispensing system or device can have. Namely, that the venting or propellant circuit should be completely separate from, and isolated from, the product circuit. This is illustrated with reference to a number of exemplary Flair based systems, as next described in connection with FIGS. 12-14.

With reference to FIG. 12, an exemplary “piston Flair” dispensing device is shown. Here, the piston Flair is used, for example, to dispense ice cream from an inner container 1210 which is pressurized by a pump 1220. The pump 1220 injects air 1230 or some other displacement medium such as a gas or a liquid in order to maintain a certain pressure underneath the inner container. As a result, the product in the inner container is continually maintained under pressure and can be easily pushed out when a user opens a valve 1240 at the top of the device. The Piston Flair system is described in detail in U.S. Patent Application Publication No. US 2011/0024450 A1, under common assignment herewith, the disclosure of which is fully incorporated herein by reference as if fully set forth.

The device is known as a “piston Flair” because the bottom portion of the inner container 1210 as shown in FIG. 12 moves upwards as inner container 1210 collapses, much like a piston moves in a piston cylinder. As can be seen with reference to FIG. 12, because the inner container 1210 is totally isolated from outer container 1250, and the displacement medium, here air 1230, supplied by pump 1220, never contacts the contents of the inner container. Thus, the venting or propellant system is totally isolated from the product delivery system and there is only a pressure transfer between the propellant system and the product delivery system, but no actual contact. This means that the inner container is always air tight, does not develop air bubbles inside it—as it is not connected to either the propellant system or to any venting—and therefore, the product can be one that should not contact air if desired. This allows for the dispensing of products which may not have preservatives and may have a longer shelf life and greater freshness.

The product is dispensed by the system creating an over pressure in the cavity between the inner and outer container relative to atmospheric pressure, such that when a user opens dispensing valve 1240, the contents of inner container 1210 naturally flows.

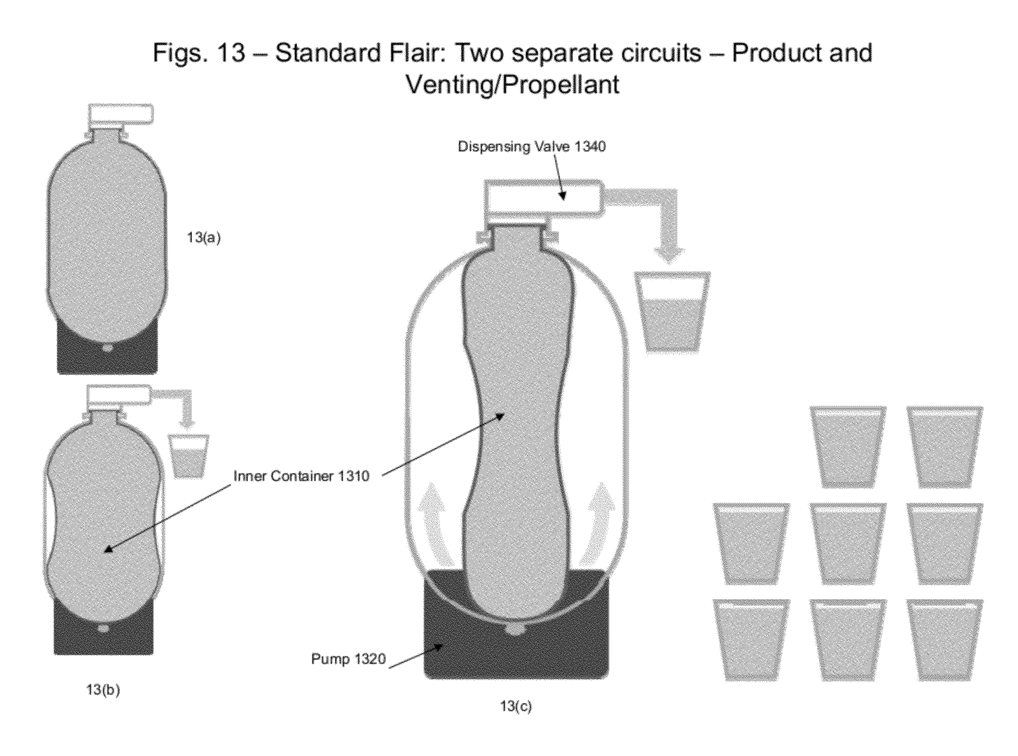

FIG. 13 depict a similar system to that shown in FIG. 12, except that the FIG. 13 system is not a piston Flair type system where the inner container moves up within the outer container in the fashion of a piston, but rather, the inner container 1310 shrinks from being a wide cylinder filling the entire outer container to being a narrow cylinder as shown in FIG. 13(c). Once again, there is a pump 1320, which supplies the displacement medium, in this case air, but could be, for example, any gas or even a liquid, which applies an over pressure to inner container 1310 such that it shrinks toward the central axis whenever a user opens a dispensing valve 1340 and allows the product to flow outwards. Thus, once again, in the example of FIG. 13, the product and the venting medium/propellant are maintained in two completely physically isolated circuits and the only interaction between them is an exchange of pressure from the venting/propellant circuit to the product delivery circuit. In other words, the pressure is applied from (i) the gap between the inner container and the outer container to (ii) the inner container.

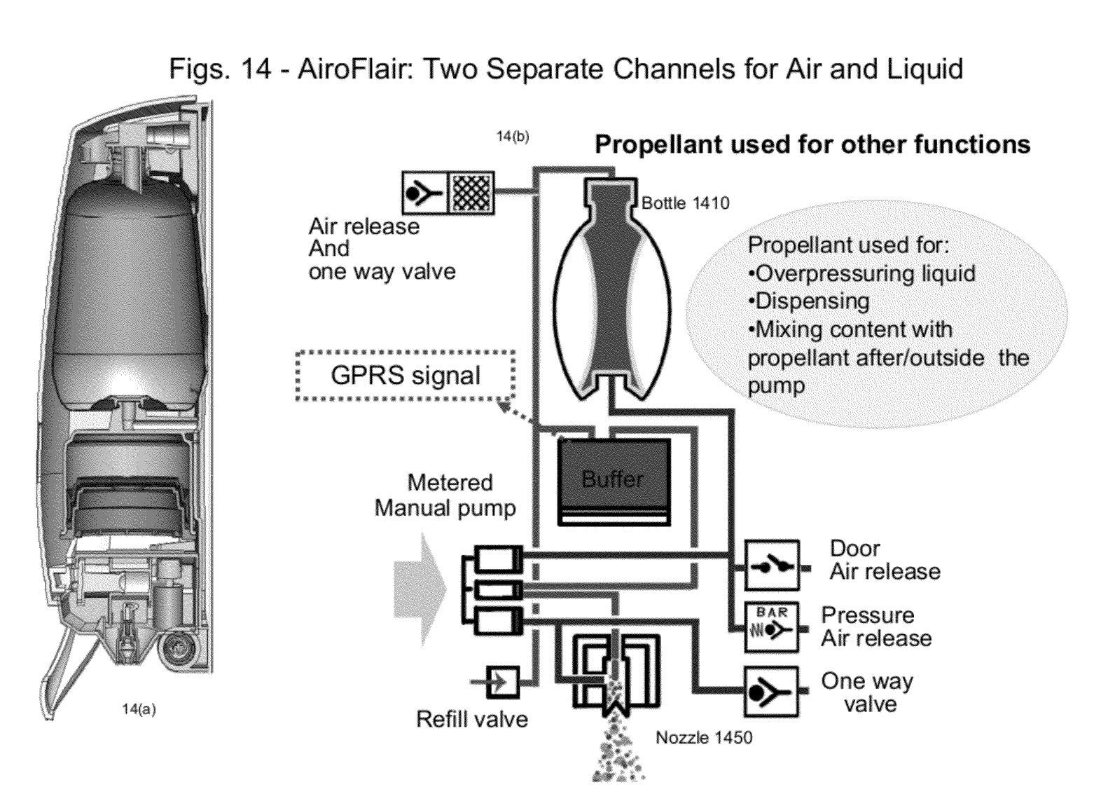

Finally, FIG. 14 show an exemplary AiroFlair based system for dispensing soap or foam from a dispensing device such as shown in FIG. 14(a). This is the system described in U.S. Provisional Patent Application. No. 61/518,677, filed on May 9, 2011, which has been incorporated herein by reference and priority to which is claimed herein.

The exemplary AiroFlair system once again maintains two absolutely isolated systems, one for the propellant/venting medium (shown in blue in FIG. 14(b)) and one for the actual product dispensed from bottle 1410 (the product and its position in the circuit all shown in red in FIG. 14(b)). The only time that the propellant circuit (here the propellant is air) and the product circuit mix or come into contact is when it is desired to mix the content with the propellant on the dispensing side (downstream) of the pump (i.e., in nozzle 1450 to create foam). In all other respects, the two circuits are absolutely separate and distinct, and do not interact.

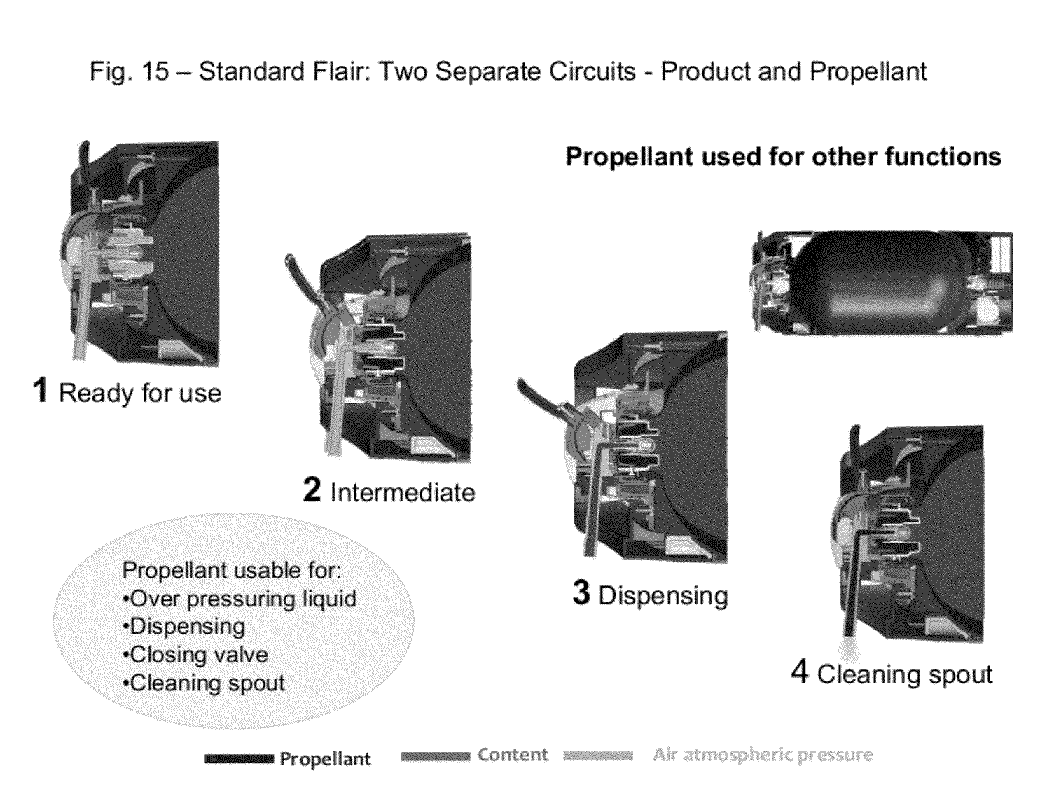

FIG. 15 illustrates the uses of providing the propellant and the product into two separate circuits. In particular, FIG. 15 illustrates the various parts of a standard Flair beverage dispensing system, such as for dispensing beer or soda, where atmospheric pressure (shown in light blue) propellant (shown in dark blue) and contents (shown in pink) are found during various steps in the dispensing process.

It is noted that the system of FIG. 15 is essentially the system shown in FIG. 13 but turned on its side and provided within a dispensing module. Such a dispensing module and the valve used therein are described in U.S. Patent Application Publication No. US2011/0210141 A1, under common assignment herewith. This patent application publication is hereby incorporated herein by this reference as if fully set forth.

As shown in panel 1 of FIG. 15, the Flair dispensing system is ready for use and the outflow tube as well as the valve is sitting at atmospheric pressure (light blue air present). In panel 1 the propellant (dark blue) is only seen between the inner container and the outer container. Inside the bottle, and essentially filling it, is the inner container containing the contents. In panel 1 the device is ready for use, but has not been actuated and therefore the handle is at its topmost vertical position.

In panel 2 of FIG. 15 a user has pulled on the beer dispensing handle, thus pulling it forward such that it now makes an angle of approximately 30° with the vertical. This causes the propellant (dark blue) to fill the valve as is seen in panel 2. However, the outlet channel or spout still has atmospheric pressure prevailing in it. It is noted that the propellant is at a higher than atmospheric pressure and thus is used to create over pressure in the dispensing process.

In panel 3, the user has pulled the dispensing arm yet farther forward such that it makes an approximately angle of 60° with the vertical. This causes the internal valve to open to a second position and let the contents flow through to the spout (the valve still has the propellant, at its higher pressure, in it). Finally, in a cleaning spout phase shown in panel 4, the user has pushed the dispensing handle back toward its original position and prior to allowing the vent and the spout to be exposed to atmospheric pressure, the device blows the propellant through the spout thus clearing it of any residue. It is here recalled, as described above, that Flair systems allow for no contact between the products to be dispensed and ambient air. This, as noted, provides that the product can be as fresh a possible and have a long shelf life. Often preservatives can be avoided. But this does not address the situation of residue of a product in the spout or outflow channel. This is handled, as shown in FIG. 4, by using the overpressure at which the propellant is maintained within the system to flow through the spout after a dispensing event such that it thoroughly cleans the spout and does not allow bacteria or other things to grow, even in the dispensing spout. This prevents the next glass of beer, for example, from being contaminated in some way with the residue of the previous glass. Thus, FIG. 15 clearly shows various uses for the propellant which are only possible by maintaining the propellant in a completely separate and distinct circuit from the product.

Finally, FIG. 16 shows a Flair sprayer, according to exemplary embodiments of the present invention. Here, we see the culmination of sprayer development where not only is there a precompression dome valve which restricts the droplet size distribution to that seen in FIG. 11, as noted above, but there is also a flair inner container/outer container system provided in the container or “bottle” portion of the sprayer such that the product never interacts with the air (or other propellant) and therefore no air bubbles of any kind enter the product circuit. Thus, all that is required to fully dispense the contents of the inner container is to maintain an overpressure between the outer container and the inner container by pressurizing the gap. In exemplary embodiments of the present invention this can be achieved by, for example, simply having a vent, as shown in FIG. 16, such that when liquid is pumped out of the inner container an under pressure is created in the gap which is immediately filled by air, or, for example as shown in FIGS. 12 and 13, a pump can be affixed to the bottom of an exemplary Flair type bottle and said pump can inject a displacing medium at a higher than atmospheric pressure, as described above. As seen in FIG. 16, at the bottom of the standard Flair container, the inner container is attached to the outer container by a small protrusion of the inner container through the outer container wall, and the vent 1650 (in the form of a set of holes surrounding the central protrusion) is provided adjacent to such protrusion.

Thus, given the examples shown in FIGS. 8-16, in traditional dispensing systems the liquid/product to be dispensed, and the air or other venting medium/propellant are uncontrolled, and allowed to be mixed up in a dispensing head via venting or re-venting valves. Moreover, these valves are normally open due to the fact that the pump will not prime if there is air inside, so they allow air to be expelled as a user initiates a downstroke. In contrast, as in exemplary embodiments of the present invention, a better method is to control the content and the propellant/re-vent medium. This can be done by (i) removing springs or resilient media from the pump chamber itself, and also by (ii) making sure that at the end of the down stroke (piston all the way forward in piston chamber), the volume of the piston chamber is complete dead (zero), so that air is completely out of the dispensing circuit. Further, by using (iii) normally closed, inlet and outlet valves (which can be integrated into one valve or provided as separate valves), which open by a predetermined pressure differential or “cracking pressure,” and finally (iv) by creating two different circuits, one for product/content and another for propellant or re-venting medium. These two circuits are wholly isolated, and only brought together, if necessary, downstream of a one-way and normally closed outlet valve to create/implement other dispensing properties and functionalities, such as, for example, clean out of outlet channel, foam creation, etc.

Thus, in exemplary embodiments of the present invention, by controlling the content and the propellant/re-vent medium a new dimension is introduced to dispensing technologies. The contents/product is controlled and will be not disturbed by external influences, from the container all the way to the nozzle output. The liquid/product is also protected in this manner from outside influences and interactions, such as, for example, contamination.

Similarly, in exemplary embodiments of the present invention, the same treatment can be provided to the propellant/vent medium. It can be provided in a separate circuit from container to the nozzle output (to the extent it is used in or near the nozzle). As a result of its isolation and availability the displacement/venting medium can be used for functions such as, for example, applying over pressure to liquid (in an inner container), dispensing, closing valves, cleaning a spout or tube, venting in response to an under-pressure, tubeless spraying/dispensing, spraying/dispensing upside down. Such systems operate not by interaction of the propellant with the product, but by pressure differentials.

1. A sprayer, comprising:
a bottle, said bottle comprising:
at least one inner container provided inside an outer container;
a one way vent on the outer surface of said bottle, through which air can enter between said inner container and said outer container; and
a sprayer head connected to the inner container in an airtight manner, said sprayer head comprising:
a piston chamber and a piston provided to slidably move therein;
an actuator connected to the piston, which moves said piston back and forth;
an inlet having a first end open to the inner container and having a second end connected to the piston chamber via a one-way valve; and
an outlet channel connected to the piston chamber via an outlet valve;
wherein in its normal configuration, the outlet valve of said sprayer head is closed and there is no open air path to the atmosphere.

2. The sprayer of claim 1, wherein when a liquid or a gas in the piston chamber has a pressure equal to or greater than a defined pressure necessary to open the outlet valve, such liquid or gas exits via the outlet channel.

3. The sprayer of claim 2, wherein said liquid or gas reaches such pressure by a user actuating the piston.

4. The sprayer of claim 3, wherein said liquid or gas continues to exit the outlet channel until its pressure falls below said defined pressure.

5. The sprayer of claim 1, wherein at least one of air and a gas can be pumped out of a headspace in the inner container.

6. The sprayer of claim 5, wherein as at least one of air, a gas and a liquid is pumped out of the inner container, air is drawn into a vent at the bottom of the bottle and enters the space between the inner container and the outer container.

7. The sprayer of claim 1, wherein no dip tube is required to convey liquid from the inner container to the sprayer head.

8. The sprayer of claim 6, wherein no dip tube is required to convey liquid from the inner container to the sprayer head.

9-10. (canceled)

11. The sprayer of claim 1, wherein the liquid in the inner container is isolated form any propellant medium provided between the inner container and the outer container.

12. A liquid dispensing device, comprising:
a main body and a dispensing head;
the main body comprising an inner container provided within an outer container;
the dispensing head comprising:
an intake piston and an intake piston chamber,
said intake piston chamber being in fluid communication with the main body;
a dome valve assembly comprising a deformable dome valve and a dome valve seal;
an orifice in fluid communication with the piston chamber when the deformable dome valve is open;
an outlet channel with a nozzle.

13. The liquid dispensing device of claim 12, wherein in a pressurizing operation, a fluid is drawn from the main body into the intake piston chamber so as to pressurize it.

14. The liquid dispensing device of claim 12, wherein the nozzle is openable and closable by user action.

15. (canceled)

16. The liquid dispensing device of claim 12, wherein said dome valve provides pre-compression to the liquid dispensing device, and wherein during a spraying operation if the pressure in the pressure chamber drops below the minimum value, then spraying terminates.

17-18. (canceled)

19. A method of dispensing a liquid from a device, comprising:
providing a liquid in within an inner container that is surrounded by an outer container;
providing a pressure chamber, said pressure chamber separated from an outlet channel by an outlet valve, said valve normally in a closed position;
drawing liquid from the inner container and pumping it under pressure into the pressure chamber until said liquid is at a pressure greater than or equal to a minimum pressure sufficient to open the outlet valve;
wherein the gap between the outer surface of the inner container and the inner surface of the outer container is open to a propellant medium source,
wherein as the liquid is sprayed from the outlet channel the propellant medium enters into such gap and causes the inner container to shrink, and
wherein the liquid is isolated from the propellant medium in the device.

20. The method of claim 19, wherein the liquid is provided to the pressure chamber by hand pumping.

21. The method of claim 19, wherein the liquid is pumped into the pressure chamber under a pressure sufficient to open a pressure chamber inlet valve.

22. The method of claim 19, wherein the minimum pressure necessary to open said pressure chamber inlet valve is less than the minimum pressure necessary to open the outlet valve.

23. The method of claim 19, wherein the propellant medium is maintained at a higher than atmospheric pressure, and is used to do at least one of (i) mix with the liquid downstream of the outlet valve to create a foam and (ii) clean the outlet channel downstream of the outlet valve, and wherein the propellant medium is one of air at atmospheric pressure, air at above atmospheric pressure, a gas, water, a liquid.

24. (canceled)

25. A method of dispensing a product, comprising:
providing the product within an inner container that is surrounded by an outer container;
providing a pressure chamber, said pressure chamber separated from an outlet channel by an outlet valve, said valve normally in a closed position;
drawing product from the inner container and pumping it under pressure into the pressure chamber until said product is at a pressure greater than or equal to a minimum pressure sufficient to open the outlet valve;
wherein a gap between the outer surface of the inner container and the inner surface of the outer container is open to source of a propellant.
wherein a product circuit is fully isolated from a propellant medium circuit in the device, and
wherein the device is operated and the product dispensed by the use of various pressure differentials.

26. The method of claim 25, wherein the propellant is maintained at one of atmospheric pressure or above atmospheric pressure, and wherein the product is dispensed by the propellant applying a pressure to the inner container.

27. (canceled)
